(19) United States
(12) Patent Application Publication
(10) Pub. No.: US 2026/0217582 A1
(43) Pub. Date: Jul. 30, 2026

(54) FILTRATION AID COMPOSITIONS AND METHODS OF USE

(71) Applicant: Locus Solutions IPCO, LLC, Solon, OH (US)

(72) Inventors: Gabriela Knesel, Solon, OH (US); Ronney Silva, Solon, OH (US); Cathrine Monyake, Solon, OH (US)

(21) Appl. No.: 19/146,240

(22) PCT Filed: Jan. 8, 2024
(86) PCT No.: PCT/US2024/010668

§ 371 Date: Jul. 8, 2025

Related U.S. Application Data
(60) Provisional application No. 63/479,104, filed on Jan. 9, 2023.
(60) Provisional application No. 63/508,604, filed on Jun. 16, 2023.

(51) Int. Cl. C02F 3/34; B01D 25/127; B01D 37/02; C02F 1/00; C02F 1/38; C02F 1/52; C02F 103/00; C02F 103/06; C02F 103/10; C02F 103/34

(52) U.S. Cl. CPC C02F 3/347; B01D 25/127; B01D 37/02; C02F 1/004; C02F 1/385; C02F 1/52; C02F 2103/001; C02F 2103/06; C02F 2103/10; C02F 2103/34; C02F 2301/063; C02F 2305/04

(57) ABSTRACT

The subject invention provides safe, environmentally-friendly compositions and efficient methods for filtering. More specifically, the subject invention provides compositions derived from microorganisms for filtering, which can be used for increasing the rate of filtering, the quality of the filtered particles, and/or the amount of filtered particles.

### CROSS-REFERENCE TO RELATED APPLICATIONS

This application claims priority to U.S. Provisional Patent Application Nos. 63/479,104, filed Jan. 9, 2023, and 63/508,604, filed Jun. 16, 2023, each of which is incorporated herein by reference in its entirety.

### BACKGROUND OF THE INVENTION

Efficiently removing deposits from the earth and reducing pollution associated with various mining and quarrying practices use methods of filtering. During mining, filtering agents can be used to separate solids from a liquid. Currently, the filtering of particles involves separating components of a mixture based on, for example, centrifugal or gravitational principles using stationary or mechanical equipment, such as, for example screens or cone filterers. Filtering of ore concentrates is important to reduce the weight and transportation costs from the mill to the smelter, roaster, or other processing plant. Filtering of tailings is also often required for compliance with environmental regulations or for efficient disposal.

Mining or excavating of rock, including quarrying, can result in the production of toxic waste pollution, including during the production of phosphate, coal, potash, tac, mica, and bentonite. The mining and subsequent production of products often uses slurries that contain the mineral, element, or other material of interest. These slurries can further contain suspended or colloidal particles that may be toxic if released into the environment, such as, for example phosphatic clay waste or coal-clay waste. Additionally, the presence of the toxic compound in the liquid can prevent efficient disposal of liquids.

In addition to the use of filtering agents for mining, a filtering agent is used in paper making, and for treating sewage sludge from municipal wastewater or stormwater. However, with conventional filtering agents, the amount of treatable sludge is limited, and the treatment conditions may not be satisfactory, including, for example, the recovery rate, the purity of the filtered liquid, and the removability of a cake from a filter cloth.

Therefore, novel, improved compositions and methods are needed for filtering.

### BRIEF SUMMARY OF THE INVENTION

The subject invention relates generally to filtration aid compositions and methods of using these compositions. More specifically, the subject invention provides environmentally-friendly filtration aid compositions and methods for filtering, such as, for example, during mining, beneficiation processes, construction, and wastewater treatment. In certain embodiments, existing methods can incorporate the subject compositions and methods.

Advantageously, the compositions and methods of the subject invention increase the efficiency of filtering and can decrease chemical usage, including chemical surfactant usage, required for filtering. Accordingly, the subject invention can be useful for reducing the time needed for mining, water treatment (e.g., mining wastewater, municipal wastewater, stormwater, industrial wastewater) or production of various products, including, for example, beer, paper or oil.

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water; chemical surfactants, including, for example, ionic surfactants and nonionic surfactants; flocculants; clarifying agents; filtration aids; or any combination thereof.

In certain embodiments, the subject compositions can be applied to the surface of filters, such as, for example, as a coating, or incorporated into filters. The filter can include, for example, a filter press cloth, oil filter, lubricant filters, air filters, hydraulic oil filter, fuel filters, or exhaust filters. In certain embodiments, the filter press cloth can comprise nylon; polyester (e.g., Avora FR® or Trevira CS®); a polyamine polymer (e.g., Rilsan®); polypropylene, including, for example, felted polypropylene, woven polypropylene, polypropylene monofilament, polypropylene multifilament, or any combination thereof. In certain embodiments, the air filter can remove dust from the air.

In certain embodiments, the subject compositions and methods can be used to filter, for example, silver, gold, copper, zinc, lead, chromium, nickel, cobalt, or molybdenum from gangue, water, or other less-valuable or toxic substances.

In certain embodiments, the biosurfactant of the composition is utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin, and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP, esterified SLP derivatives, amino acid-SLP conjugates, and other SLP derivatives or isomers that exist in nature and/or are produced synthetically. In preferred embodiments, the SLP is a linear SLP or a derivatized linear SLP.

In certain embodiments, the subject invention provides a method for filtering, wherein the method comprises the following steps:
a) contacting a filtration aid composition comprising a biosurfactant with a liquid containing a solid or a semisolid particle; and
b) filtering the solid or semisolid particle from the liquid.

In certain embodiments, the removal of the solid or semisolid particle can be performed using a pressurized flow of a liquid or centrifugation or using gravitational principles, or a combination thereof, including, for example, plate and frame filter press.

In some embodiments, the filtered particles that can be less than about 10 cm, about 1 cm, about 1 mm, about 500 μm, about 100 μm, about 10 μm, about 1 μm, about 100 nm, about 10 nm, or about 1 nm in diameter.

In some embodiments, the method comprises contacting a filtration aid composition comprising a biosurfactant and, optionally, other components, such as, for example, water, chemical surfactants, flocculants, clarifying agents, or filtration aids. In certain embodiments, the filtration aid composition can be contacted to the liquid for a period of time and/or until a distinct volume of the filtration aid composition has been contacted to the liquid. The step can be repeated as many times as necessary to achieve a rate of filtering or until a desired amount of solid or semisolid particles are removed from the liquid.

In certain embodiments, the filtration aid composition according to the subject invention is effective due to enhancing and/or increasing the rate of accumulation of the particles or the total amount of the filtered particles from a liquid containing said particles by adsorbing the particles onto the filter aid. For example, in some embodiments, a sophorolipid will form a micelle containing or linking the particles, wherein the micelle is less than 500 μm, less than 100 μm, less than 10 μm, less than 1 μm, less than 100 nm, less than 50 nm, less than 25 nm, less than 15 nm or less than 10 nm in size.

In certain embodiments, the methods of the subject invention result in at least a 25% increase in the amount of the filtered particles when compared to a liquid that is filtered without the use of the subject filtration aids, preferably at least a 50% increase, after one treatment. In certain embodiments, the liquid composition can be treated multiple times to further increase the amount of filtered particles.

Advantageously, in certain embodiments, the filtration aid composition according to the subject invention can be effective at filtering toxic solids or semisolids out of liquids. Furthermore, the methods of the subject invention do not require complicated equipment or high energy consumption, and production of the composition can be performed on site, for example, at a mine or at a wastewater treatment facility.

### DETAILED DESCRIPTION

The subject invention relates generally to the filtering of particles out of liquids. More specifically, the subject invention provides environmentally-friendly compositions and methods for filtering, such as, for example, filtering liquids that are produced at mining sites, wastewater, and liquids derived from or used in industrial activities. Accordingly, the subject invention is useful for improving the efficiency and efficacy of methods of filtering. Advantageously, the compositions and methods of the subject invention increase the filtering of particles using safe, environmentally-friendly compositions.

### Selected Definitions

As used herein, “applying” a composition or product refers to contacting it with a target or site such that the composition or product can have an effect on that target or site. The effect can be due to, for example, microbial growth and/or the action of a biosurfactant or other microbial growth by-product.

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or using naturally-derived substrates.

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect.

Biosurfactants accumulate at interfaces, thus reducing interfacial tension and leading to the formation of aggregated micellar structures in solution. The formation of micelles provides a physical mechanism to mobilize, for example, oil in a moving aqueous phase.

The ability of biosurfactants to reduce the surface tension also permits their use as antibacterial, antifungal, and hemolytic agents to, for example, control pests and/or microbial growth.

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

Like chemical surfactants, each biosurfactant molecule has its own HLB value depending on its structure; however, unlike production of chemical surfactants, which results in a single molecule with a single HLB value or range, one cycle of biosurfactant production typically results in a mixture of biosurfactant molecules (e.g., subtypes and isomers thereof).

The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

In certain embodiments, the biosurfactant is a sophorolipid (SLP). As used herein, the term “sophorolipid,” “sophorolipid molecule,” “SLP” or “SLP molecule” includes all forms, and isomers thereof, of SLP molecules, including, for example, acidic (linear) SLP (ASL) and lactonic SLP (LSL). Further included are mono-acetylated SLP, di-acetylated SLP, esterified SLP, SLP with varying hydrophobic chain lengths, cationic and/or anionic SLP with fatty acid-amino acid complexes attached, esterified SLP, SLP-metal complexes, SLP-salt derivatives (e.g., a sodium salt of a linear SLP), and other, including those that are and/or are not described within in this disclosure.

Sophorolipids are glycolipid biosurfactants produced by yeasts when cultivated in the presence of a hydrocarbon-based source of one or more fatty acids. Sophorolipid-producing yeasts can include Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi.

SLP typically consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-Δ9-octadecenoic acid. The hydroxy fatty acid is generally 16 or 18 carbon atoms, and may contain one or more unsaturated bonds. Furthermore, the sophorose residue can be acetylated on the 6- and/or 6′-position(s). The fatty acid carboxyl group can be free (acidic or linear form (General Formula 2)) or internally esterified at the 4″-position (lactonic form (General Formula 1)). S. bombicola produces a specific enzyme, called S. bombicola lactone esterase, which catalyzes the esterification of linear SLP to produce lactonic SLP.

In preferred embodiments, the SLP according to the subject invention are represented by General Formula (1) and/or General Formula (2), and include 30 or more structural homologs:

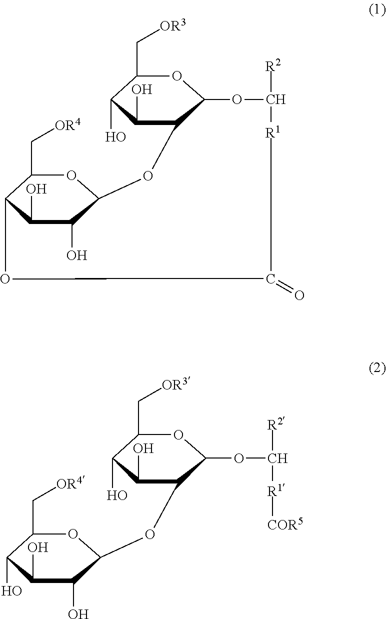

where R¹ and R^{1′} independently represent saturated hydrocarbon chains or single or multiple, in particular single, unsaturated hydrocarbon chains having 8 to 20, in particular 12 to 18 carbon atoms, more preferably 14 to 18 carbon atoms, which can be linear or branched and can comprise one or more hydroxy groups, R² and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups, and R³, R^{3′}, R⁴ and R^{4′} independently represent a hydrogen atom or —COCH₃.

The composition utilized according to the subject methods can comprises more than one form of SLP, including linear SLP and lactonic SLP. The SLP can be non-acetylated, mono-acetylated and/or di-acetylated SLP.

In certain specific embodiments, the composition comprises SLP according to General Formula (1) (linear SLP) wherein R¹ and/or R² are an acetyl group, and wherein R³ is derived from a stearic, oleic and/or linoleic fatty acid.

SLP have environmental compatibility, high biodegradability, low toxicity, high selectivity and specific activity in a broad range of temperature, pH and salinity conditions. Additionally, in some embodiments, SLP can be advantageous due to their small micelle size, which can help facilitate the movement of the micelle, and compounds enclosed therein, through nanoscale pores and spaces. In certain embodiments, the micelle size of a SLP is less than 100 nm, less than 50 nm, less than 20 nm, less than 15 nm, less than 10 nm, or less than 5 nm.

In certain embodiments, the glycolipid is a rhamnolipid. Rhamnolipids comprise a glycosyl head group (i.e., a rhamnose) moiety, and a 3-(hydroxyalkanoyloxy)alkanoic acid (HAA) fatty acid tail, such as, e.g., 3-hydroxydecanoic acid. Two main subtypes of rhamnolipids exist, mono- and di-rhamnolipids, which comprise one or two rhamnose moieties, respectively. The HAA moiety can vary in length and degree of branching, depending on, for example, the growth medium and the environmental conditions. The highest accumulation of rhamnolipids (RLP) has been shown by submerged cultivation of Pseudomonas spp., such as P. aeruginosa.

Rhamnolipids according to the subject invention can have the following structure, according to General Formula (3):

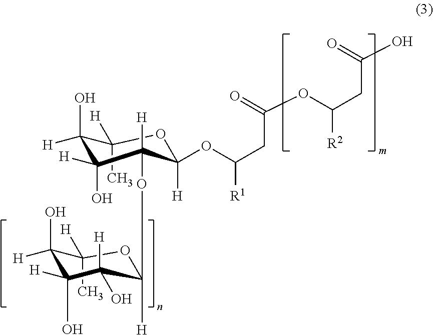

wherein m is 2, 1 or 0,
n is 1 or 0,
R¹ and R² are, independently of one another, the same or a different organic functional group having 2 to 24, preferably 5 to 13 carbon atoms, in particular a substituted or unsubstituted, branched or unbranched alkyl functional group, which can also be unsaturated,
wherein the alkyl functional group is a linear saturated alkyl functional group having 8 to 12 carbon atoms, or is a nonyl or a decyl functional group or a mixture thereof.

Salts of these compounds are also included according to the invention. In the present invention, the term “di-rhamnolipid” is understood to mean compounds of the above formula or the salts thereof in which n is 1. Accordingly, “mono-rhamnolipid” is understood in the present invention to mean compounds of the general formula or the salts thereof in which n is 0. In certain specific embodiments, the composition comprises a mixture of mono- and di-rhamnolipids. As used herein, “granulation” refers to the process of forming granules by aggregating particles. Methods of granulation include the use of an impeller, screw, or compressed air in which the particles are agitated. The methods may also employ rollers (rotating cylinders) for compressing the particles. For example, the rollers may be two counter-rotating rollers, through which the particles are passed and compressed.

As used herein, “filtering” refers to the process by which a solid or semisolid particle is removed from a liquid, for example, by passing the liquid through a filter medium through which the solid or semisolid particle cannot pass.

As used herein, a “semisolid” or “quasi-solid” particle is a substance that has an intermediate viscosity and rigidity between that a liquid and a solid.

As used herein, “beneficiation” refers to the process by which gangue materials are removed from the product of interest (e.g., element, compound, mineral).

As used herein, “ore” refers to a naturally occurring solid material from which a valuable substance, mineral and/or metal can be profitably extracted. Ores are often mined from ore deposits, which comprise ore minerals containing the valuable substance. “Gangue” minerals are minerals that occur in the deposit but do not contain the valuable substance. Examples of ore deposits include hydrothermal deposits, magmatic deposits, laterite deposits, volcanogenic deposits, metamorphically reworked deposits, carbonatite-alkaline igneous related deposits, placer ore deposits, residual ore deposits, sedimentary deposits, sedimentary hydrothermal deposits and astrobleme-related deposits. Ores, as defined herein, however, can also include ore concentrates or tailings.

As used herein, “leaching” refers to the process by which metal is extracted from ore by aqueous solutions including by, for example, ammonia leaching, alkali leaching, acid leaching, cyanidation (i.e., cyanide leaching), or thiosulfate leaching. As used herein “cyanidation” refers to the process of converting gold in ore to a water-soluble coordination complex using aqueous cyanide, including, for example, sodium cyanide, potassium cyanide, or calcium cyanide.

As used herein, “colloid” or “colloidal particle” refers to a mixture in which one insoluble substance is dispersed or suspended throughout another substance. The insoluble substance is generally dispersed in a liquid.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Filtration Aid Compositions

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water, chemical surfactants, clarifying agents, flocculants, filtration aids, or any combination thereof.

In certain embodiments, the chemical surfactant of the filtration aid composition is a detergent, wetting agent, emulsifier, foaming agent, and/or dispersant. In certain embodiments, the chemical surfactants, include, for example, ionic and/or nonionic surfactants. In certain embodiments, the ionic surfactants can be, for example, fatty alcohol sulfates (e.g., sodium dodecyl sulfate or ammonium dodecyl sulfate); fatty alcohol ether sulfates; alkyl sulfoacetates; fatty alcohol phosphoric acid esters; fatty alcohol ether phosphates; alcohol phosphoric acid esters, including, for example, triisobutyl phosphate, monoalkyl or dialkyl esters of sulfosuccinic acid (e.g., dioctyl sodium sulfosuccinate, alkyl sulfonates, alkylbenzenesulfonates, including, for example, dodecylbenzenesulfonic acid); and nonionic surfactants, including, for example, fatty alcohol ethoxylates (e.g., alkylphenol ethoxylates, polyoxyethylene fatty acid esters, polypropylene glycol ethoxylates, fatty acid mono- and diglycerides, fatty acid glycol partial esters, sorbitan fatty acid esters, or polyoxyethylene sorbitan fatty acid esters).

In certain embodiments, the filtration aids include, for example, conventional filtration aids, such as, for example, diatomaceous earth, charcoal, perlite, asbestos, cellulose, or fly ash. Filtration aids can be chemicals that assist in solid-liquid separation by modifying the surface properties of minerals, elements, or other substances to enhance water repellency. The filtration aids impart a hydrophobic character to particles so that interstitial water is reduced to a minimum. Flocculants or clarifying agents constitute types of filtration aids; by binding the particles together, they prevent the particles from binding to the filter medium and inhibiting the movement of the liquid through the filter medium. In certain embodiments, the flocculants include, for example, chitosan. In certain embodiments, the filtration aids include an adsorbent, such as a silica gel, and at least one filtration aid component that may be chosen from natural glasses, such as, for example, expanded perlite, pumice, expanded pumice, pumicite, expanded obsidian, and expanded volcanic ash, and biogenic silicas, such as, for example, diatomite, rice hull ash, and sponge spicules. In a further embodiment, the at least one filtration aid component may further be chosen from buoyant glasses, buoyant polymers, and celluloses.

In certain embodiments, the filtration aid composition comprises a microbe-based product comprising a biosurfactant utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP derivatives, esterified SLP derivatives, amino acid-SLP conjugates, and other SLP derivatives or isomers that exist in nature and/or are produced synthetically. In preferred embodiments, the SLP is a linear SLP or a derivatized linear SLP. In certain embodiments, the subject compositions can comprise lactonic and linear SLP, with at least about 50%, about 55%, about 60%, about 65%, about 70%, about 75%, about 80%, about 85%, about 90%, or about 95% of the SLP comprising linear forms, and the remainder comprising lactonic forms.

In some embodiments, the biosurfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total filtration aid composition.

In another embodiment, a purified biosurfactant may be added in combination with an acceptable carrier, in that the biosurfactant may be presented at concentrations of 0.001 to 50% (v/v), preferably, 0.01 to 20% (v/v), more preferably, 0.02 to 5% (v/v).

In some embodiments, the biosurfactant can be included in the composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of liquid being treated.

In certain embodiments, the chemical surfactant of the filtration aid composition is a detergent, wetting agent, emulsifier, foaming agent, and/or dispersant. In some embodiments, the chemical surfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total filtration aid composition.

In some embodiments, the conventional filtration aid, flocculant, and/or clarifying agent can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total filtration aid composition.

The filtration aid composition can further comprise other additives such as, for example, carriers, other microbe-based compositions, additional biosurfactants, enzymes, catalysts, solvents, salts, buffers, chelating agents, acids, emulsifying agents, lubricants, solubility controlling agents, preservatives, stabilizers, ultra-violet light resistant agents, viscosity modifiers, preservatives, tracking agents, and other microbes and other ingredients specific for an intended use.

In certain embodiments, chelating agents can be, but are not limited to, ethylenediaminetetraacetic acid (EDTA), nitrilotriacetic acid (NTA), a phosphonate, succimer (DMSA), diethylenetriaminepentaacetate (DTPA), N-acetylcysteine, n-hydroxyethylethylenediaminetriacetic acid (HEDTA), organic acids with more than one coordination group (e.g., rubeanic acid), STPP (sodiumtripolyphosphate, Na5P3010), trisodium phosphate (TSP), water, carbohydrates, organic acids with more than one coordination group (e.g., citric acid), lipids, steroids, amino acids or related compounds (e.g., glutathione), peptides, phosphates, nucleotides, tetrapyrrols, ferrioxamines, ionophores, orphenolics, sodium citrate, sodium gluconate, ethylenediamine disuccinic acid (EDDS), iminodisuccinic acid (IDS), L-glutamic acid diacetic Acid (GLDA), GLDA-Na4, methyl glycindiacetic acid (MGDA), polyaspartic acid (PASA), hemoglobin, chlorophyll, lipophilic β-diketone, and (14,16)-hentriacontanedione, ethylenediamine-N,N′-diglutaric acid (EDDG), ethylenediamine-N,N′-dimalonic acid (EDDM), 3-hydroxy-2,2-iminodisuccinic acid (HIDS), 2-hydroxyethyliminodiacetic acid (HEIDA), pyridine-2,6-dicarboxylic acid (PDA), trimethyl glycine (TMG), Tiron, or any combination thereof.

### Methods of Filtering

In certain embodiments, the subject invention provides a method for filtering liquids from various sources, including, for example, mining sites, quarrying sites, wastewater sites, agricultural sites, food and beverage production sites, and industrial sites.

In certain embodiments, the filtration aid compositions can be applied to a filter or other surface before the liquid containing particles is moved through the filter. In certain embodiments, the filtration aid can form a layer on the filter or other surface. In certain embodiments, this precoating of the filter or other surface may reduce the amount of particles that decrease the flow of the liquid through the filter, i.e., reduce the amount of particles that clog the filter. In certain embodiments, the application of the filtration aid composition to the filter or other surface can allow for efficient removal of a filter cake, which is the insoluble material that remains on the filter at the end of the filtration process. In certain embodiments, the filter cake can be removed from the filter at the end of the filtration process or during the filtration process.

In certain embodiments, this precoating process in which the filtration aid composition may initially be applied to a surface in a process known as “pre-coating.” Pre-coating generally involves introducing the filtration aid composition in a stream flowing through the filter. During this process, a thin layer, such as about 1.5 mm to about 3.0 mm, of the filtration aid composition can be deposited on the filter, thus forming a filtration device.

In certain embodiments, the filtration aid composition can be contacted with the liquid containing the particle before introducing the liquid containing the particles to the filter. The addition of filter aids to the liquid can increase the porosity of the particles, decrease the compressibility, and reduce the resistance of the liquid passing through the filter cake.

In certain embodiments, the subject invention provides a method for filtering liquid tailings from mines. The method comprises adding the subject compositions to the tailings and removing the solid or semisolid particles from the produced liquid tailings. By filtering the tailings, the particles can reach a higher concentration after filtration. In preferred embodiments, the tailings are low-grade tailings, in which the tailings comprise less than about 50%, about 40%, about 35%, about 30%, or about 25% of the product of interest (e.g., metal, mineral, compound or element being mined), with the remainder comprising gangue.

In certain embodiments, the mining site can be a coal mine, iron ore mine (e.g., taconite), copper mine, copper-nickel mine, tin mine, nickel mine, gold mine, silver mine, molybdenum mine, aluminum mine (e.g., bauxite mine, kyanite mine), lead-zinc mine, tungsten mine, phosphate mine, potash mine, mica mine, bentonite mine, or zinc mine. The mine can be an underground mine, surface mine, placer mine or in situ mine. In certain embodiments, a variety of toxic compounds can be derived from mining activities. In certain embodiments, methods of removing said toxic compounds are provided according to the subject methods by contacting the filtering compounds to various liquid streams, piping, pumps, liquid storage areas, or aquatic environments. The toxic compounds can include, for example, cyanide, sulfur-bearing minerals, soluble iron, and heavy metals, such as, for example, molybdenum, tungsten, chromium, manganese, nickel, arsenic, and vanadium. In certain embodiments, the quarrying site can extract chalk, clay, cinder, coal, sand, gravel, coquina, diabase, gabbro, granite, gritstone, gypsum, limestone, marble, ores, phosphate rock, quartz, sandstone, slate, travertine, or any combination thereof.

In certain embodiments, a liquid can be pumped or otherwise added to the geological formation containing the element, mineral, compound, or other material of interest before the mineral, compound, or other material of interest is extracted. In certain embodiments, the subject compositions and methods can be used to filter the extracted slurries.

In certain embodiments, the subject compositions and methods can be used to extract a liquid from a mining or quarrying site by applying the composition to the liquid at the site before the liquid is pumped or otherwise removed from the site. In certain embodiments, the source of the liquid at the mining or quarrying site can be groundwater or precipitation.

In certain embodiments, the microbe-containing and/or biosurfactant-containing composition can improve agglomeration between the particles or agglomeration of particles to a filtration aid composition, such as, for example, adsorbing coal mining toxic byproducts to the surface of a filtration aid.

In certain embodiments, the microbe-containing and/or biosurfactant-containing composition can form a layer of agglomerated particulate around and/or between particles suspended in a liquid.

The compositions can be applied to liquids or vessels that contain liquids that reside at a range of temperatures and aquatic environments, such as, for example, a stream, river, waterway, ocean, sea, lake, pond, runoff area, containment ponds, filter, piping, press, screen filter, cone filter, filterer, classifier, scraper, hydrocyclone, agitator, drum, disk, or wastewater treatment/holding tank. In certain embodiments, the filtration aid composition can be added to the vessels that contain liquids before the liquid composition is added to said vessel.

The filtration aid composition can be applied to a liquid and, optionally, mixed by adding, pouring, or combining.

In certain embodiments, the time period in which the filtration aid composition can be contacted to a liquid and/or filter is for about 1 second to about 1 year, about 1 minute to about 1 year, about 1 minute to about 6 months, about 1 minute to about 1 month, about 1 minute to about 1 week, about 1 minute to about 48 hours, about 30 minutes to 40 hours, or preferably about 12 hours to 24 hours. In certain embodiments, the methods comprise applying a liquid or solid form of the filtration aid composition to the liquid for the period of time in which liquid containing particles is being produced or until the amount of particles that have been filtered out of the liquid is determined to be satisfactory or safe, which can be readily determined by one skilled in the art. The amount of particles removed from the liquid that may be considered acceptable and/or safe depends on the context. For example, the amount of particles remaining in the liquid after filtration may be acceptable in lower amounts at gold mining sites than at nickel mining sites, where it may be acceptable to have less efficient filtering.

In certain embodiments, the amount of the filtration aid composition applied is about 0.00001 to 15%, about 0.00001 to 10%, about 0.0001 to 5%, about 0.001 to 3%, about 0.01%, or about 1 vol % based on an amount of liquid that is treated.

In certain embodiments, the methods of the subject invention result in at least a 25% increase in the amount of the filtered particles when compared to a liquid that is filtered without the use of the subject filtration aids, preferably at least a 50% increase, after one treatment. In certain embodiments, the liquid composition can be treated multiple times to further increase the amount of filtered particles. In certain embodiments, the methods of the subject invention result in at least a 25% increase in the rate of filtration when compared to a liquid that is filtered without the use of the subject filtration aids, preferably at least a 50% increase, after one treatment.

In certain embodiments, the filtration aid composition according to the subject invention is effective due to amphiphiles-mediated adhesion of the particles. In some embodiments, the sophorolipid or other biosurfactant serves as a vehicle for facilitating filtering of particulate matter and/or adhesion of particulate matter to a surface and/or object. For example, in some embodiments, a sophorolipid will form a micelle containing a particle, wherein the micelle is less than 1 mm, 100 μm, 50 μm, 20 μm, 10 μm, 1 μm, 100 nm, less than 50 nm, less than 25 nm, less than 15 nm or less than 10 nm in size. The small size and amphiphilic properties of the micelle allow for enhanced adhesion of the particle so that greater agglomeration of particles can occur, allowing for a more efficient filtering process to occur.

In certain embodiments, the filtration aid compositions can be used in methods of processing ores, ore slurries, or other products obtained via mining. In certain embodiments, the filtration aid compositions can be used for filtering before and/or during concentrate filtering, tailings filtering, middling filtering, or any combination thereof.

In certain embodiments, the filtration aid compositions can be used in beneficiation processes, particularly in low-grade ores containing low concentrations of the element or other product of interest, such as, for example, gold or silver. In order to extract the element or compound of interest, it can be necessary to crush and grind the ore and preconcentrate or separate the element or product of interest from the ore by flotation or gravity separation (i.e., settling). In certain embodiments, a filtration aid composition can be added to the liquid resulting from flotation or gravity separation; said liquid can be moved through a filter to further remove particles from the liquid.

In certain embodiments, the filtration aid compositions can be used in methods of leaching, such as, for example, gold cyanidation. The process of extraction by leaching includes leaching (e.g., cyanide leaching), washing and filtering of leaching pulp, extraction of the metal from the leaching solution or pulp, and smelting of finished products. In certain embodiments, the filtration aid compositions can be used in methods of washing and filtering leaching pulp, in which the filtration aid compositions increase the rate and/or efficiency of filtering of the leaching pulp. In certain embodiments, the filtration aid compositions can filter heavy metals and metalloids including, for example, As, Cd, Co, Cu, Hg, Mn, Ni, U, and Zn, in the mined tailings, which can present a significant potential ecological and human health risk associated with metal and metalloid exposure from contaminated soils around mined tailings storage sites.

In certain embodiments, the filtration aid composition can be used in methods of treating sewage and sewage water containing water-soluble organic substances. Additionally, the filtration aid compositions can be used in methods of water purification. The purification process uses activated sludge treatment for the removal of soluble organic substances from water or other liquids. In certain embodiments, activated sludge treatment uses the growth of microorganisms for processing, so filtering the sludge out of the water is often used. In certain embodiments, sludge filtering can use traditional filtering agents. In certain embodiments, the subject filtration aid compositions can be used instead of or in conjunction with charcoal, sand, and gravel. Cationic filtering agents can neutralize negative charges on the surface of colloidal particles in sludge and can bridge between particles to form large and strong flocs for easily filtering. Sludge containing flocs can be dehydrated by sludge filtering equipment, separated to solids, and disposed of in a landfill, incineration, or compost. The filtered water can be used for irrigation, livestock consumption, recharging aquifers, or human use or consumption.

In certain embodiments, the filtering methods can reduce the amount of water in the sludge by about at least about 50%, about 60%, about 70%, or about 80%.

In certain embodiments, the filtration aid composition can be used in various industrial methods, including in the manufacturing or processing of food, beverages, oil and gas production, and paper. During oil and gas production, the subject filter aid compositions can be applied to drilling or completion fluids or as a coating to a filter to reduce the amount of particles in the various fluids used in oil and gas drilling, extracting, and refining processes. Any particulate matter in the fluids used in the production of oil and gas can damage a geological formation or oil and gas reservoir or reduce the permeability of the rock formations. In certain embodiments, the subject compositions can be use in lateral fluid filtration, completion fluid and brine filtration, frac water flow-back recycling, and/or dewatering of solids for sludge pit remediation.

In certain embodiments, the filtration aid composition can be used to remove impurities from various cosmetics, including, for example, perfumes, colognes, lotions, and creams. The filtrations aids can be used in methods that remove, for example, salts or compounds containing aluminum, calcium, magnesium, zinc, copper, antimony, manganese, chromium, or cadmium. In certain embodiments, the filtration aid compositions can be used with diatomaceous earth to filter cosmetics or other substances.

In certain embodiments, the filtration aid composition can be used in methods of making wine. In certain embodiments, the filtration aid compositions can be used with perlites, cellulose, silites, diatomaceous earth, activated carbon (e.g., charcoal), or any combination thereof to filter wine or other substances, particularly during a precoating process in which the filtration aid composition and the perlites, cellulose, silites, diatomaceous earth, activated carbon, or any combination thereof are applied to a filter element before the wine passes through the filter element. In certain embodiments, the filtration aid composition can be used to remove, for example, tartaric acid crystals, large particles, sediment, haze, colloidal proteins, bacteria, yeast, or any combination thereof.

In certain embodiments, the filtration aid composition can be used in methods of filtering pharmaceutical compositions and biological products, such as, for example, blood plasma, blood fractions, animal sera, fermentation broth, cell culture media, or bacterial culture media. In certain embodiments, the filtration aid compositions can be used with activated carbon to filter pharmaceuticals or other substances. In certain embodiments, the filtration aid composition can be used to remove pharmaceutical intermediates or impurities.

In certain embodiments, the filtration aid composition can be used in methods of electricity generation, such as, for example, in hydroelectric plants, nuclear power plants, fossil fuel power plants, and hydrogen generation stations. In certain embodiments, the filtration aid composition can be used in the filtration of intake water that is used in the electricity generation station for cooling, to generate steam, or to turn turbines in order to remove, for example, insoluble or colloidal particles from the intake water.

In certain embodiments, the filtration aid composition can be used in methods of filtering bulk chemicals such as, for example, acids, bases, or solvents. In certain embodiments, the filtration aid compositions can be used with activated carbon to filter bulk chemicals or other substances. In certain embodiments, the filtration aid composition can be used to remove bulk chemical intermediates or impurities. In certain embodiments, the bulk chemical is produced at a large scale for global consumption; these bulk chemicals include, for example, acetone, ammonia, sulfuric acid, acrylic acid, sodium hydroxide, biodiesel, castor oil, glycerin, or white spirit.

In certain embodiments, the subject composition can be used in methods of filtration, which are used to separate solids or semisolids from liquids. It is used principally in filtering flotation concentrates and tailings, such as, for example, in order to clarify a decanted solution; in collecting precipitated solids; or in removing pregnant solution from leached solids during hydrometallurgical processes.

In certain embodiments, the filtration aid compositions of the subject invention can be used to reduce the moisture content of the solid or semisolid particles filtered out of a liquid, when compared to a solid or semisolid that is not treated with the subject filtration aid compositions. In certain embodiments, the methods of the subject invention result in at least a 5% decrease in the amount of the moisture in the filtered particles when compared to a particles that is filtered without the use of the subject filtration aids, preferably at least a 10% decrease, after one treatment. In certain embodiments, the liquid composition can be treated multiple times to further decrease the amount of moisture in the filtered particles, such as, for example, at least a 15%, 20%, or 25% decrease in the moisture content in the filtered particles. In certain embodiments, the moisture content of a particle can be determined by measuring the weight loss after drying, the Karl Fischer titration to detect the amount of water in the particle using a titration with the Karl Fischer reagent, or any other known technique for detecting moisture content of a particle.

In certain embodiments, a filtration device can be used in the subject methods that comprises both a filter element, such as a filter medium or filter cartridge, and filtration aid composition. The filter element may be of any form such that it may support a filtration aid composition, such as, for example a cylindrical tube or wafer-like structure covered with a plastic or weaved metal fabric. The filter element may be a porous structure comprising a void to allow material of a certain size to pass through the filtration device. The filtration aid composition may comprise one or more filtration components, as described herein. Such a filtration aid composition may be used in combination with a filter element to enhance filtration performance. In certain embodiments, the addition of the subject filter aid compositions to the filter element can reduce the cohesive and adhesive properties between the particles that are being filtered out of a liquid and the filter element. In certain embodiments, the surface tension and/or hydrostatic pressure of the liquid being filtered can be reduced using the subject compositions and methods. In certain embodiments, the reduced cohesive and adhesive properties between the particles that are being filtered out of a liquid and the filter element and the reduced surface tension and/or hydrostatic pressure of the liquid being filtered can increase the filtering efficiency, by, for example, allowing a higher rate of filtering with an equivalent energy use to, for example, power a pump, or allow for a decreased energy use for filtering an equivalent amount of a liquid relative to a liquid that has not been contacted to a filter aid composition. In certain embodiments, the efficiency of filtering can be increased by at least about 5%, 10%, 15%, or about 25%.

In certain embodiments, the filter element can be, for example, filter press cloth, oil filter, lubricant filters, air filters, hydraulic oil filter, fuel filters, or exhaust filters. In certain embodiments, the filter press cloth can comprise nylon; polyester (e.g., Avora FR® or Trevira CS®); a polyamine polymer (e.g., Rilsan®); polypropylene, including, for example, felted polypropylene, woven polypropylene, polypropylene monofilament, polypropylene multifilament, or any combination thereof. In certain embodiments, the air filter can remove dust from the air. The filter can be a multifilament, monofilament, or a spun yard. In certain embodiments, the filter is, for example, a plain weave, basket weave, oxford weave, satin weave, twill weave, or leno weave. In certain embodiments, the type of filter press is a caulked, gasketed, and recessed (CGR) filter plate; recessed, non-gasketed (NG) filter plate; center feed filter plate; corner feed filter plate; membrane filter plate; or a plate and frame filter plate. In certain embodiments, the filter element can be disposable. In certain embodiments, the subject compositions and methods can reduce the amount of obstructions or the severity of obstructions of the . . . filter element.

In certain embodiments, the filter and/or filter aid composition has a permeability ranging from about 0.001 to about 1000 Darcies (“Da”) or about 0.05 Da to about 10 Da. The range of permeability may allow for either a high flow rate or a lower flow rate, when compared to a filtration process without the subject filtration aid composition. For example, a lower flow rate may be about 1 ml/min·cm², while a high flow rate may be at least about 100 L/min·cm². In a further embodiment, the flow rate ranges from about 1 to about 100 ml/min·cm².

Filtration can comprise pneumatic techniques. Of the various types of filters, the most common is the vacuum filter. A vacuum is applied across a membrane cloth, horizontally mounted on rotating drums or rotating disks, the lower segments of which are immersed in pulp in a tank. The feed pulp or slurry is kept in suspension by rotary agitators. Pumps suck the liquid through the filter but leave the caked solids behind. Before the drum or disk reaches the tank again, the vacuum shuts off and pressurized air is applied to dislodge the filter cake, or alternatively, scrapers remove the filter cake into a discharge chute.

In certain embodiments, after the liquid containing the particles, such as, for example, a gold slurry, has been filtered. The remaining gangue can be retained in a tailings pond, disposed of at a waste facility, or, preferably, temporarily stored in a holding tank and the returned to the geological formation from which the gangue is derived.

Advantageously, in certain embodiments, the filtration aid composition according to the subject invention provides enhanced or increased efficiency of filtering particles with limited negative environmental impacts. Additionally, the methods of the subject invention do not require complicated equipment or high energy consumption, and the production of the filtration aid composition can be performed on site, including, for example, at a mine or at an industrial site. In certain embodiments, the subject filtration aid composition can result in a decreased use of chemical surfactants, synthetic filtering agents, or other potentially harmful chemicals used for filtering.

Reducing the Carbon Footprint and/or Carbon Intensity

In certain embodiment, a unit of liquid, such as a cubic foot or any other unit, is monitored to evaluate the attainment of the goal(s). Preferably, the monitoring is quantitative. In one embodiment, carbon credits are earned as well as other current or future environmental benefits market in which individuals or companies are compensated for engaging regenerative and/or environmentally sustainable practices that reduce the use of fossil fuels that generate carbon dioxide, methane, and nitrous oxide but also conserve water in which the carbon intensity (such as described by the Argonne GREET model) is reduced, neutral, or even negative.

A “carbon footprint” may be defined herein as a measure of the total amount of carbon dioxide (CO₂) and other GHGs emitted directly or indirectly by a human activity or accumulated over the full life cycle of a product or service. As just one example, a heavy product that requires transportation over many miles by truck (e.g., mined ores containing a high moisture content) may have a larger carbon footprint than an alternative product that does not have a high weight (e.g., ores that have a low moisture content).

Carbon footprints can be calculated using a Life Cycle Assessment (LCA) method, the Argonne GREET model, or can be restricted to the immediately attributable emissions from energy use of fossil fuels. An LCA, also known as life cycle analysis, ecobalance, and cradle-to-grave analysis) is the investigation and valuation of the environmental impacts of a given product or service caused or necessitated by its existence. The life cycle concept of the carbon footprint means that it is all-encompassing and includes all possible causes that give rise to carbon emissions. In other words, all 20 direct (on-site, internal) and indirect emissions (off-site, external, embodied, upstream, downstream) need to be taken into account.

Normally, a carbon footprint is expressed as a CO₂ equivalent or in some markets as a carbon intensity (CI) score. Carbon dioxide equivalency is a quantity that describes, for a given mixture and amount of GHG, the amount of CO₂ that would have the same global warming potential (GWP), when measured over a specified timescale (generally, 100 years). Carbon dioxide equivalency thus reflects time-integrated radiative forcing. The carbon dioxide equivalency for a gas is obtained by multiplying the mass and the GWP of the gas. The following units are commonly used:
a) By the UN climate change panel IPCC: billion metric tonnes of CO₂ equivalent (GtCO₂ eq);
b) In industry: million metric tonnes of carbon dioxide equivalents (MMTCDE);
c) For vehicles: g of carbon dioxide equivalents/km (gCDE/km).

For example, the GWP for methane is 21 and for nitrous oxide 310. This means that emissions of 1 million metric tonnes of methane and nitrous oxide respectively is equivalent to emissions of 21 and 310 million metric tonnes of carbon dioxide.

Various methods exist in the art for calculating or estimating carbon footprints and may be employed in the subject invention.

Advantageously, in preferred embodiments, the subject invention can be useful for reducing the carbon footprint of mining, water purification, cosmetic production, pharmaceutical production, electricity generation, filtering fluids (e.g., hydraulic fluids), wine making, and producing chemicals.

A “reduced carbon footprint” means a negative alteration in the amount of carbon dioxide and other GHGs emitted per unit time over the full life cycle of producing a product, through and until a product is ultimately consumed by human consumers or performing a task (e.g., electricity generation). The negative alteration in CO₂ and/or other GHG emissions can be, for example, at least 0.25%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

In some embodiments, the term “carbon footprint” is interchangeable herein with the terms “carbon intensity” and “emission intensity.” Emission intensity is the measure of the emission rate of a given GHG relative to the “intensity” of a specific activity or industrial process (e.g., burning of fuel or the processing of gold ore). The emissions intensity can include emission amount relative to, for example, amount of fuel combusted, yield of refined gold, amount of a commercial product produced, total distance traveled, and/or number of economic units generated.

Emissions intensity is measured across the entire life cycle of a product. For example, the emissions intensity of fuels is calculated by compiling all of the GHG emissions emitted along the supply chain for a fuel, including all the emissions emitted in exploration, mining, collecting, producing, transporting, distributing, dispensing and burning the fuel.

In addition to reducing the carbon footprint and/or carbon intensity of mining, in some embodiments, the subject invention can be used for reducing the number of carbon credits used by an operator involved in, e.g., mining and refining.

Advantageously, the systems of the subject invention can increase the efficiency and reduce the financial and environmental costs of mining practices. In particular, the compositions and methods utilized according to the subject invention can help in preserving valuable natural resources, such as soil and water, while improving production of commodities.

In one embodiment, the methods and compositions according to the subject invention lead to a decrease in emissions of GHG, such as, for example, CO₂, N₂O and/or CH₄, or atmospheric particulates by at least about 1%, about 5%, about 10%, about 20%, about 30%, about 40%, about 50%, about 60%, about 70%, about 80%, about 90%, about 100%, about 150%, about 200%, or more, compared to similar untreated liquid containing a solid or a semisolid particle.

### Monitoring of GHG

In some embodiments, the systems of the subject invention further involve the monitoring of various inputs and outputs of filtration. For example, following application of a filtration aid composition to a filtration element, factors such as water usage and generation of GHG emissions or other atmospheric particulates, and fossil fuel usage can be monitored. Accordingly, the system can be adjusted throughout implementation to account for changes in these factors and make appropriate adjustments to the inputs.

In some embodiments, monitoring comprises performing one or more measurements to assess the effect of the methods of the subject invention on the generation and/or reduction in generation of GHGs or other atmospheric particulates. In certain embodiments, the measurements assess the effect of the methods of the subject invention on the generation and/or reduction in generation of GHGs or other atmospheric particulates.

Measurements and/or monitoring can be conducted at a certain time point after application of the filtration aid composition to the filter element or other site. In some embodiments, the measurements are conducted after about 1 week or less, 2 weeks or less, 3 weeks or less, 4 weeks or less, 30 days or less, 60 days or less, 90 days or less, 120 days or less, 180 days or less, 1 year or less and/or 2 years or less. In preferred embodiments, the measurements are conducted at the end of the lifespan of the filter element and/or when a filter cake is removed.

Furthermore, the measurements and/or monitoring can be repeated over time. In some embodiments, the measurements are repeated daily, weekly, monthly, bi-monthly, semi-monthly, semi-annually, and/or annually.

In certain embodiments, assessing GHG generation can take the form of measuring GHG emissions from a site. Gas chromatography with electron capture detection is commonly used for testing samples in a lab setting. In certain embodiments, GHG emissions can also be conducted at a site, using, for example, flux measurements and/or other developing analytical tools, including, for example, a spectrometric system.

Measuring GHG emissions can also comprise other forms of direct emissions measurement, gas chromatography-mass spectrometry (GC-MS) and/or analysis of fuel input. Direct emissions measurements can comprise, for example, identifying polluting operational activities (e.g., fuel-burning automobiles or trains) and measuring the emissions of those activities directly through Continuous Emissions Monitoring Systems (CEMS). Fuel input analysis can comprise calculating the quantity of energy resources used (e.g., amount of electricity, fuel, wood, biomass, etc., consumed) determining the content of, for example, carbon, in the fuel source, and applying that carbon content to the quantity of the fuel consumed to determine the amount of emissions.

In some embodiments, the aspects of the system can be centralized such that they are managed, facilitated and/or performed by a single entity. The entity can be a company or a person who manages, facilitates and/or performs all aspects of producing the filtration aid compositions, formulation and/or customization of the compositions, transportation and application of the compositions, and monitoring of inputs and outputs throughout the course of the treatment. The central entity can also utilize input and output data collected from a single customer and/or multiple customers to predict and formulate future adjustments to the prescribed filtration program.

In some embodiments, the central entity can serve as a general contractor, with sub-contractors performing one or more of the production, formulation/customization, transportation and application of the filtration compositions, as well as monitoring.

### Production of Microbe-Based Products

In certain embodiments, the subject invention provides methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus, B. laterosporus, B. megaterium); Blakeslea, Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus); Williopsis spp.; and/or Zygosaccharomyces spp. (e.g., Z. bailii).

In preferred embodiments, microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g. small molecules and excreted proteins), residual nutrients and/or intracellular components (e.g. enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

In certain embodiments, the subject invention provides a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10³, 1×10⁴, 1×10⁵, 1×10⁶, 1×10⁷, 1×10⁸, 1×10⁹, 1×10¹⁰, 1×10¹¹, 1×10¹², 1×10¹³ or more CFU per milliliter of the composition.

The subject invention further provides “microbe-based products,” which are products that are to be applied in practice to achieve a desired result. The microbe-based product can be simply a microbe-based composition harvested from the microbe cultivation process. Alternatively, the microbe-based product may comprise further ingredients that have been added. These additional ingredients can include, for example, stabilizers, acids, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

We claim:

1. A method of filtering, the method comprising:
a) contacting a filtration aid composition comprising a biosurfactant with a liquid containing a solid or a semisolid particle; and
b) filtering the solid or semisolid particle out of the liquid.

2. The method of claim 1, wherein step b) further comprises centrifugation, settling, or a combination thereof.

3. The method of claim 1, wherein the filtering comprises using a plate and frame filter press or a belt filter press.

4. The method of claim 1, wherein the filtering comprises applying a vacuum across a filter.

5. The method of claim 1, wherein the liquid is a wastewater or a slurry of ore.

6. The method of claim 5, wherein the wastewater is municipal wastewater, stormwater, mining wastewater, quarrying wastewater, groundwater, precipitation, or industrial wastewater.

7. The method of claim 5, wherein the wastewater or slurry of ore is from a coal mine, iron ore mine, copper mine, copper-nickel mine, tin mine, nickel mine, gold mine, silver mine, molybdenum mine, aluminum mine, lead-zinc mine, tungsten mine, phosphate mine, potash mine, mica mine, bentonite mine, or zinc mine.

8. The method of claim 7, wherein the aluminum mine is a kyanite mine or a bauxite mine.

9. The method of claim 1, wherein the filtration aid composition further comprises a chemical surfactant, flocculant, clarifying agent, filtration aid, water, or any combination thereof.

10. The method of claim 1, wherein step b) comprises moving the liquid through the filtration aid composition.

11. The method of claim 1, wherein step a) comprises mixing the liquid with the filtration aid composition.

12. The method of claim 1, wherein step a) comprises mixing the liquid with the filtration aid composition and step b) comprises moving the liquid through the filtration aid composition.

13. The method of claim 1, wherein the biosurfactant is a sophorolipid and/or a yeast culture comprising a sophorolipid.

14. The method of claim 13, wherein the yeast culture is a Starmerella sp. and/or a Candida sp. yeast.

15. The method of claim 13, wherein the yeast is in a vegetative state.

16. The method of claim 13, wherein the yeast is in a spore form.

17. The method of claim 1, wherein the filtering comprises removing the solid or semisolid particle from the liquid by one or a combination of the following:
a) adhering the particle to the filtration aid composition;
b) agglomerating particles together; or
c) adsorbing particles in the liquid to the filtration aid composition.

18. A method of filtering, the method comprising;
a) contacting a filtration aid composition comprising a biosurfactant with a liquid containing a solid or a semisolid particle; and
b) filtering the solid or semisolid particle out of the liquid, yielding a filtered particle, wherein the filtering occurs at an increased rate compared with a liquid that is not contacted to the biosurfactant, thereby increasing the efficiency of filtering and reducing the carbon footprint of filtering.

19. The method of claim 18, wherein step b) further comprises centrifugation, settling, or a combination thereof.

20. The method of claim 18, wherein the filtering comprises using a plate and frame filter press or a belt filter press.

21. The method of claim 18, wherein the filtering comprises applying a vacuum across a filter.

22. The method of claim 18, wherein the liquid is a wastewater or a slurry of ore.

23. The method of claim 22, wherein the wastewater is municipal wastewater, stormwater, mining wastewater, quarrying wastewater, groundwater, precipitation, or industrial wastewater.

24. The method of claim 22, wherein the wastewater or slurry of ore is from a coal mine, iron ore mine, copper mine, copper-nickel mine, tin mine, nickel mine, gold mine, silver mine, molybdenum mine, aluminum mine, lead-zinc mine, tungsten mine, phosphate mine, potash mine, mica mine, bentonite mine, or zinc mine.

25. The method of claim 24, wherein the aluminum mine is a kyanite mine or a bauxite mine.

26. The method of claim 18, wherein the filtration aid composition further comprises a chemical surfactant, flocculant, clarifying agent, filtration aid, water, or any combination thereof.

27. The method of claim 18, wherein step b) comprises moving the liquid through the filtration aid composition.

28. The method of claim 18, wherein step a) comprises mixing the liquid with the filtration aid composition.

29. The method of claim 18, wherein step a) comprises mixing the liquid with the filtration aid composition and step b) comprises moving the liquid through the filtration aid composition.

30. The method of claim 18, wherein the biosurfactant is a sophorolipid and/or a yeast culture comprising a sophorolipid.

31. The method of claim 30, wherein the yeast culture is a Starmerella sp. and/or a Candida sp. yeast.

32. The method of claim 30, wherein the yeast is in a vegetative state.

33. The method of claim 30, wherein the yeast is in a spore form.

34. The method of claim 18, wherein the filtering comprises removing the solid or semisolid particle from the liquid by one or a combination of the following:
a) adhering the particle to the filtration aid composition;
b) agglomerating particles together; or
c) adsorbing particles in the liquid to the filtration aid composition.

35. The method of claim 18, further comprising:
c) transporting the solid or semisolid particle, wherein the transporting of the solid or semisolid particle results in reduced greenhouse gas emissions compared with a particle that is not contacted to the biosurfactant, thereby reducing the carbon footprint of transporting the filtered particle.

36. The method of claim 35, further comprising measuring the amount of the fossil fuel used to transport the filtered particle, wherein the amount of the fossil fuel used to transport the filtered particle is reduced when compared to a particle that has not been treated with the biosurfactant.

37. The method of claim 35, further comprising measuring moisture content of the filtered particle, wherein the moisture content of the filtered particle is reduced when compared to a particle that has not been treated with the biosurfactant.

38. The method of claim 18, further comprising measuring filtration rate of the liquid, wherein the filtration rate is increased when compared to a liquid that has not been treated with the biosurfactant.

39. The method of claim 38, further comprising measuring the amount of the fossil fuel used to filter the liquid,
wherein the amount of the fossil fuel used to filter the liquid is reduced or about equivalent when compared to a liquid that has not been treated with the biosurfactant.

40. A filtration aid composition comprising a sophorolipid and/or a yeast culture comprising a sophorolipid and one or more traditional filtering components.

41. The composition of claim 40, wherein the yeast culture is a Starmerella sp. and/or a Candida sp. yeast.

42. The composition of claim 40, wherein the yeast is in a vegetative state.

43. The composition of claim 40, wherein the yeast is in a spore form.

44. The composition of claim 40, wherein the traditional filtering components are selected from one or a combination of the following:
a) chemical surfactant;
b) flocculant;
c) filtration aid; or
d) clarifying agent.
